(19) United States
(12) Patent Application Publication
(10) Pub. No.: US 2024/0218119 A1
(43) Pub. Date: Jul. 4, 2024

(54) MODIFIED POLYHYDROXYALKANOATES AND METHODS OF MAKING THEREOF

(71) Applicant: TerraVerdae Bioworks Inc., Edmonton (CA)

(72) Inventors: Asghar Dolatkhah, Edmonton (CA); Raymond John Bergstra, Edmonton (CA)

(21) Appl. No.: 18/541,219

(22) Filed: Dec. 15, 2023

Related U.S. Application Data
(60) Provisional application No. 63/432,785, filed on Dec. 15, 2022.

(51) Int. Cl. C08G 63/91; C08G 63/82

(52) U.S. Cl. CPC C08G 63/912; C08G 63/823; C08G 2230/00

(57) ABSTRACT

Provided herein are modified polyhydroxyalkanoates and methods of making the same. The modified polyhydroxyalkanoates are made via thermolysis of a polyhydroxyalkanoate and a plant-based acid acting as a nucleophile.

### CROSS-REFERENCE TO RELATED APPLICATIONS

This application claims priority to U.S. Provisional Application No. 63/432,785 entitled “MODIFIED POLYHYDROXYALKANOATES AND METHODS OF MAKING THEREOF”, filed Dec. 15, 2022, the entire contents of which are incorporated by reference herein.

### FIELD OF THE DISCLOSURE

The present disclosure is in the technical field of biobased and biodegradable polymer materials. More specifically, the present disclosure is in the field of polyhydroxyalkanoate polymers with low crystallinity and methods of making the same.

### BACKGROUND

Polymers with low crystallinity or that are amorphous provide a range of desirable properties, such as tackiness and response to temperature. High crystallinity polymers tend to lose tackiness upon crystallization, whereas amorphous polymers tend to exhibit unlimited or long-term tackiness. Amorphous polymers also tend to soften and demonstrate gradual reduced viscosity in response to higher temperatures as opposed to a discrete melting temperature. This is due to the random nature of the molecular structure and lack of long-range order in polymer structure. Due to these effects, polymers with low crystallinity and amorphous polymers are less prone to shrinkage as they cool.

The response to temperature increase also means that the polymers are highly malleable and easily deformed, which makes them well suited for bonding to substrate materials. When applied to a substrate and dried above their glass transition temperature, which tend to be low, polymers with low crystallinity or amorphous polymers provide good film forming capabilities.

Many polymers with these characteristics are currently used as adhesives, including acrylics, epoxies, silicones, polyurethanes, and rubber. However, these polymers tend to be synthetic or derived from synthetic materials, and are not readily biodegradable.

What is needed are biodegradable polymers that are amorphous or that have low crystallinity, with properties suitable for use in adhesives.

### SUMMARY OF DISCLOSURE

Provided herein are modified polyhydroxyalkanoates (PHAs) and compositions containing the modified PHAs. The modified PHAs have the formula:

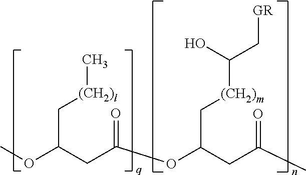

wherein l is an integer from 0 to 20, m is an integer from 0 to 20, n and q are integers wherein the sum of n and q is from 20 to 200, the ratio of q to n is between 0 and 1, and GR is a plant-based acid nucleophile. In some embodiments, l is an integer from 1 to 5. In some embodiments, m is an integer from 1 to 6. In still further embodiments, the ratio of q to n is from about 0.01 to about 0.20. In still further embodiments, the ratio of q to n is from about 0 to about 0.01. In an exemplary embodiment, the modified PHA has the formula:

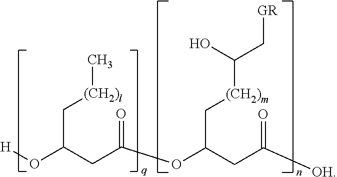

In some embodiments, GR is a diterpene acid or a derivative thereof. In an exemplary embodiment, GR has the formula:

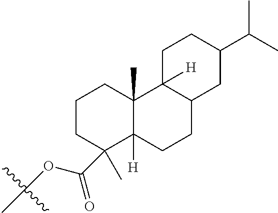

In some embodiments, the modified PHA has a molecular weight from about 5,000 Da to about 60,000 Da. In some aspects, the modified PHA has a molecular weight from about 5,000 Da to about 10,000 Da, from about 10,000 Da to about 20,000 Da, from about 20,000 Da to about 30,000 Da, from about 30,000 Da to about 40,000 Da, from about 40,000 Da to about 60,000 Da, or from about 5,000 Da to about 15,000 Da. Compositions of the present disclosure may contain mixtures of modified PHA polymers having varying molecular weights.

In some embodiments, the modified PHA is semicrystalline. In some aspects, the modified PHA has a crystallinity of about 10% or less, about 5% or less, about 3% or less, or about 1% or less. In some examples, the modified PHA is amorphous. In some additional embodiments, the modified PHA is thermoset.

In some embodiments, the composition has a glass-transition temperature (T_{g}) from about −50° C. to about 20° C., from about −40° C. to about 0° C., from about −30° C. to about −5° C., or from about −20° ° C. to about −8° C.

Further provided herein are compositions comprising a modified polyhydroxyalkanoate (PHA), wherein the modified PHA comprises 3-hydroxyalkanoate monomer units or 4-hydroxyalkanoate monomer units. In some embodiments, the 3-hydroxyalkanoate monomer units or the 4-hydroxyalkanoate monomer units include from 1 to 3 points of unsaturation. In some additional embodiments, the 3-hydroxyalkanoate monomer units or the 4-hydroxyalkanoate monomer units are derived from unsaturated fatty acids. In still further embodiments, greater than 30%, 30% to 60%, 60% to 99%, or 30% to 99% of the 3-hydroxyalkanoate monomer units or the 4-hydroxyalkanoate monomer units comprise an epoxide functional group at a terminus of a side chain. In preferred embodiments, the modified PHA has low levels of cross-linking.

In some embodiments, the modified PHA comprises from about 0% to about 20% 3-hydroxyalkanoate monomer units. In some aspects, the 3-hydroxyalkanoate monomer units comprise a carbon chain having from 4-30 carbons, wherein the carbon chain includes at least one point of unsaturation. In some examples, the carbon chain has from 12-24 carbons. In another embodiment, the modified PHA comprises 3-hydroxyalkanoate monomer units including a carbon chain having 11 carbon atoms and a point of unsaturation at a terminus of the carbon chain.

In some embodiments, the modified PHA comprises from about 0% to about 20% 4-hydroxyalkanoate monomer units. In some aspects, the 4-hydroxyalkanoate monomer units comprise a carbon chain having from 4-30 carbons, wherein the carbon chain includes at least one point of unsaturation. In some examples, the carbon chain has from 12-24 carbons.

In an exemplary embodiment, the modified PHA comprises from about 0% to about 20% monomers that are derived from 3-hydroxy-10-undecylenic acid.

Further provided herein are methods for synthesizing modified polyhydroxyalkanoates (PHAs). The methods generally comprise contacting an epoxidized PHA with a plant-based acid acting as a nucleophile in the presence of a catalyst, thereby forming the modified PHA. In some embodiments, the methods further comprise epoxidizing a PHA comprising a monomer unit with at least one point of unsaturation to form an epoxidized PHA prior to the contacting. In some aspects, the epoxidizing is performed by contacting the PHA with an epoxidizing agent.

In some embodiments, the catalyst comprises an amine catalyst. In some examples, the amine catalyst comprises ammonia, primary amines, secondary amines, tertiary amines, or combinations thereof.

In some embodiments, the contacting occurs at a temperature from about 50° C. to about 160° C., or from about 100° C. to about 140° C. In an exemplary embodiment, the contacting occurs at a temperature from about 120° C.

In some embodiments, the contacting occurs for a period from about 1 hour to about 7 days, or from about 8 hours to about 48 hours. In an exemplary embodiment, the contacting occurs for a period of about 24 hours.

In some embodiments, the epoxidized PHA comprises less than 1% benzoic acid, less than 0.1% benzoic acid, or less than 0.01% benzoic acid. Preferably, the epoxidized PHA is substantially free of benzoic acid.

Further provided herein are methods for synthesizing modified PHAs. The methods generally comprise epoxidizing a PHA having the formula:

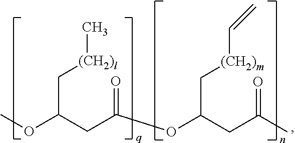

thereby forming an epoxidized PHA having the formula:

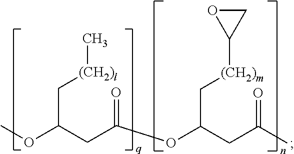

and contacting the epoxidized PHA with a plant-based acid acting as a nucleophile in the presence of a catalyst, thereby forming the modified PHA, wherein l is an integer from 0 to 20, m is an integer from 0 to 20, n and q are each integers greater than or equal to zero, wherein the sum of n and q is from 1 to 200, and the ratio of q to n is between 0 and 1.

Further provided herein is a method for synthesizing modified PHAs. The methods generally comprise oxidizing a PHA having the formula:

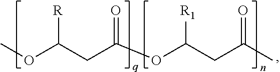

thereby forming an oxidized PHA having the formula:

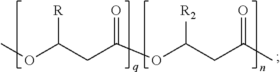

and contacting the oxidized PHA with a plant-based acid acting as a nucleophile in the presence of a catalyst, thereby forming the modified PHA, wherein R is H, CH₃, or a C₂-C₂₇ alkyl; R₁ is a C₂-C₂₁ alkenyl; R₂ is an epoxide or a C₁-C₂₇ epoxide; n is an integer from 20 to 200; and the ratio of q to n is from 0 to 1. Preferably, R₂ is an epoxide derivative of R₁.

Further provided herein are compositions comprising a modified polyhydroxyalkanoate (PHA) having the formula:

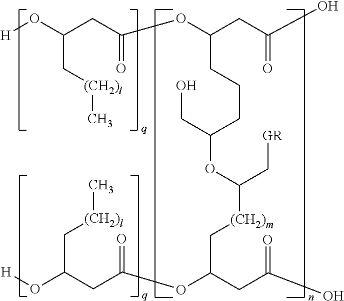

wherein l=4, m=5, n is an integer from 30 to 50, x is an integer from 20-30, and GR is a plant-based acid nucleophile.

Further provided herein are compositions comprising modified PHAs, the composition comprising a first PHA having the formula:

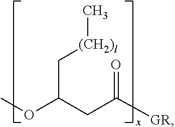

and a second PHA having the formula:

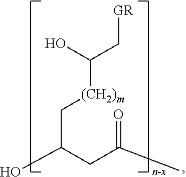

wherein l=4, m=5, n is an integer from 30 to 50, the ratio of q to n is from 0 to 1, and GR is a plant-based acid nucleophile.

### BRIEF DESCRIPTION OF THE FIGURES

FIG. 1 is a dynamic scanning calorimetry thermogram of a modified PHA of the present disclosure.

FIG. 2 is a gel permeation chromatogram showing the molecular weight distribution of a modified PHA of the present disclosure.

### DETAILED DESCRIPTION

Described herein are compounds, including modified polyhydroxyalkanoates (PHAs), that are amorphous or that have low crystallinity, and methods of making the same. The compositions described herein may be used in a wide variety of common plastic applications including but not limited to films, sheets, injection molded articles, thermoformed articles, blow molding, adhesives, coatings, sealants, polymer dispersions, etc.

### I. Compositions

The modified compounds and PHA compositions described herein are formed via thermolysis of PHAs and plant-based acids acting as nucleophiles. The modified PHA compositions are preferably viscous and tacky, thus making them suitable for use in adhesives.

PHAs and methods of making and procuring PHAs are generally known in the art. PHAs can be produced naturally using renewable carbon sources rather than non-renewable, petroleum-based carbon sources. PHAs also naturally degrade with no residues, meaning that improperly discarded PHA material has little or no long-term effect on the environment. Waste PHA material may managed through a variety of waste-recovery and upcycling streams such as chemical recycling, biodigestion, and composting.

PHAs may be classified based on the length of the carbon side chain in the hydroxyalkanoate monomer unit. As an example, the monomer unit for a poly-3-hydroxyalkanoate is shown below:

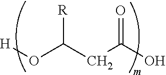

where m is an integer greater than 0 (e.g., up to about 10,000 Da) and R═H, alkyl, substituted alkyl, heteroalkyl, substituted heteroalkyl, alkenyl, substituted alkenyl, heteroalkenyl, substituted heteroalkenyl, alkynyl, substituted alkynyl, heteroalkynyl, or substituted heteroalkynyl. When R contains a 1-2 length carbon chain, the PHA is considered a short-chain length PHA (also referred to as a “scl-PHA”). A common scl-PHA is polyhydroxybutyrate (PHB). When R contains a 3-9 length carbon chain, the PHA is considered a medium-chain length PHA (also referred to as a “mcl-PHA”). When R contains a 10+ length carbon chain, the PHA is considered a long-chain length PHA (also referred to as a “lcl-PHA”). Preferably, R is linear, and defines a side chain.

As understood herein by way of example, if R was a C₄ alkyl, then the poly-3-hydroxyalkanoate monomer unit would be understood to have a total carbon chain length of 7 carbons, a side chain length of 4 carbons, and a main carbon chain length of 3 carbons.

As another example, the monomer unit for a poly-4-hydroxyalkanoate is shown below:

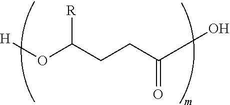

where m is an integer greater than 0 and R═H, alkyl, substituted alkyl, heteroalkyl, substituted heteroalkyl, alkenyl, substituted alkenyl, heteroalkenyl, substituted heteroalkenyl, alkynyl, substituted alkynyl, heteroalkynyl, or substituted heteroalkynyl. Preferably, R is linear, and defines a side chain.

The PHA monomer unit may comprise a point of unsaturation along the side chain. The point of unsaturation acts as a reactive site for the addition of a plant-based acid acting as a nucleophile. Thus, in some examples, the PHA monomer unit may comprise an alkenyl, substituted alkenyl, heteroalkenyl, or substituted heteroalkenyl side chain or combinations thereof.

The PHA monomer unit used to make the compounds and/or modified PHA compositions of the present disclosure may comprise a 3-hydroxyalkanoate unit. The 3-hydroxyalkanoate unit may have a carbon chain length from 4 carbons to 30 carbons; for example, 4 carbons to 10 carbons, 4 carbons to 15 carbons, 4 carbons to 20 carbons, 4 carbons to 25 carbons, 4 carbons to 30 carbons, 10 carbons to 15 carbons to 30 carbons, 20 carbons to 30 carbons, or 25 carbons to 30 carbons. The 3-hydroxyalkanoate may comprise a point of unsaturation along the side chain.

The PHA monomer unit used to make the compounds and/or modified PHA compositions of the present disclosure may comprise a 4-hydroxyalkanoate unit. The 4-hydroxyalkanoate unit may have a carbon chain length of from 4 carbons to 30 carbons; for example, 4 carbons to 10 carbons, 4 carbons to 15 carbons, 4 carbons to 20 carbons, 4 carbons to 25 carbons, 4 carbons to 30 carbons, 10 carbons to 15 carbons to 30 carbons, 20 carbons to 30 carbons, or 25 carbons to 30 carbons. The 4-hydroxyalkanoate may comprise a point of unsaturation along the side chain.

The PHA monomer unit used to make the compounds and/or modified PHA compositions of the present disclosure may form a mixed copolymer of a 3-hydroxyalkanoate and 4-hydroxyalkanoate. The mixed copolymer may be a random copolymer. The 3-hydroxyalkanoate and/or the 4-hydroxyalkanoate of the mixed copolymer may have a carbon chain length of from 4 carbons to 30 carbons; for example, 4 carbons to 10 carbons, 4 carbons to 15 carbons, 4 carbons to 20 carbons, 4 carbons to 25 carbons, 4 carbons to 30 carbons, 10 carbons to 15 carbons to 30 carbons, 20 carbons to 30 carbons, or 25 carbons to 30 carbons. The mixed copolymer may comprise a point of unsaturation along the side chains of the 3-hydroxyalkanoate and/or the 4-hydroxyalkanoate monomer units.

The PHA monomer unit used to make the compounds and/or modified PHA compositions of the present disclosure may comprise a side-chain derived from unsaturated fatty acids. For example, the side chain may be derived from oleic acid, where R═C₅H₁₀(CH)₂C₈H₁₇. In another example, the side chain may be derived from undecylenic acid, where R═C₆H₁₂CHCH₂. The unsaturated fatty acid may be any unsaturated fatty acid known in the art, including α-linolenic acid, stearidonic acid, eicosapentaenoic acid, cervonic acid, linoleic acid, linoleaidic acid, γ-linolenic acid, dihomo-γ-linolenic acid, arachidonic acid, docosatetraenoic acid, palmitoleic acid, vaccenic acid, paullinic acid, oleic acid, elaidic acid, gondoic acid, erucic acid, nervonic acid, mead acid, and other unsaturated fatty acids known in the art and combinations thereof.

The PHA undergoes thermolysis with a plant-based acid acting as a nucleophile. As used herein “plant-based” means that the acid is derived from a natural source such as starch sugars, cellulosic sugars, waste organics, vegetable based oils, vegetable based fatty acids, or other plant-based sources, and combinations thereof. The plant-based acid acting as a nucleophile may include diterpene resin acids and colophony, or derivatives thereof. Derivatives of diterpene resin acids and colophony include functionalized diterpene resin acids an colophony, wherein the natural diterpene resin acids and colophony are modified by the addition of one or more functional groups. Diterpene resin acids are generally known in the art, and have been described in Keeling, C. I.; Bohlmann, J., “Diterpene resin acids in conifers” Phytochemistry 2006, 67, 2415-2423, as well as in Wu, Z.; Li, J.; Huang, P.; Sun, Z.; Li, H.; Zhang, W., “New ent-kaurane diterpenoid acids from Nouelia insignis Franch and their anti-inflammatory activity” RSC Advances, 2022, 12, 11155-11163, the entire contents of which are incorporated by reference herein. Some non-limiting examples of diterpene resin acids include abietic acid, levopimaric acid, neoabietic acid, palustric acid, isopimaric acid, sandaracopimaric acid, pimaric acid, dehydroabietic acid, agathic acid, isocupressic acid, trans-communic acid, and combinations thereof. The plant-based acid acting as a nucleophile may comprise a gum rosin. In preferred embodiments, the plant-based acid acting as a nucleophile comprises a gum rosin having the formula:

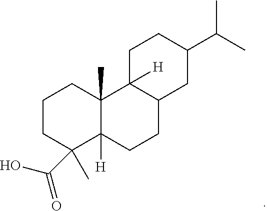

Some non-limiting examples of commercially available gum rosins that may also be used include ARDYME, FR Rosin, and HYPALE gum rosins from Arakawa Chemical; Lytor® and NovaRes® gum rosins from Bakelite Synthetics; EMULTROL gum rosins from Concentrol; Rositene gum rosins from Crowley Chemical, DERMULSENE gum rosins from DRT, and others known in the art.

The modified PHA of the present disclosure comprises a terminus at either end of the polymer chain. The terminus may comprise H, a hydroxyl group (—OH), or -GR.

The modified PHA of the present disclosure may have a number-average molecular weight (Mₙ) from about 5,000 Da to about 60,000 Da, such as about 5,000 Da, about 10,000 Da, about 15,000 Da, about 20,000 Da, about 25,000 Da, about 30,000 Da, about 35,000 Da, about 40,000 Da, about 45,000 Da, about 50,000 Da, about 55,000 Da, or about 60,000 Da. In some embodiments, the modified PHA of the present disclosure may have a molecular weight from about 5,000 Da to about 10,000 Da, about 5,000 Da to about 15,000 Da, about 5,000 Da to about 20,000 Da, about 5,000 Da to about 25,000 Da, about 5,000 Da to about 30,000 Da, about 5,000 Da to about 35,000 Da, about 5,000 Da to about 40,000 Da, about 5,000 Da to about 45,000 Da, about 5,000 Da to about 50,000 Da, about 5,000 Da to about 55,000 Da, about 5,000 Da to about 60,000 Da, about 10,000 Da to about 60,000 Da, about 15,000 Da to about 60,000 Da, about 20,000 Da to about 60,000 Da, about 25,000 Da to about 60,000 Da, about 30,000 Da to about 60,000 Da, about 35,000 Da to about 60,000 Da, about 40,000 Da to about 60,000 Da, about 45,000 Da to about 60,000 Da, about 50,000 Da to about 60,000 Da, or about 55,000 Da to about 60,000 Da.

Compositions containing the modified PHA of the present disclosure may include a mixture of modified PHAs of the present disclosure, wherein the mixture of modified PHAs have an average molecular weight (Mₙ) from about 5,000 Da to about 60,000 Da, such as about 5,000 Da, about 10,000 Da, about 15,000 Da, about 20,000 Da, about 25,000 Da, about 30,000 Da, about 35,000 Da, about 40,000 Da, about 45,000 Da, about 50,000 Da, about 55,000 Da, or about 60,000 Da. In some embodiments, the mixture of modified PHAs have an average molecular weight (Mₙ) from about 5,000 Da to about 10,000 Da, about 5,000 Da to about 15,000 Da, about 5,000 Da to about 20,000 Da, about 5,000 Da to about 25,000 Da, about 5,000 Da to about 30,000 Da, about 5,000 Da to about 35,000 Da, about 5,000 Da to about 40,000 Da, about 5,000 Da to about 45,000 Da, about 5,000 Da to about 50,000 Da, about 5,000 Da to about 55,000 Da, about 5,000 Da to about 60,000 Da, about 10,000 Da to about 60,000 Da, about 15,000 Da to about 60,000 Da, about 20,000 Da to about 60,000 Da, about 25,000 Da to about 60,000 Da, about 30,000 Da to about 60,000 Da, about 35,000 Da to about 60,000 Da, about 40,000 Da to about 60,000 Da, about 45,000 Da to about 60,000 Da, about 50,000 Da to about 60,000 Da, or about 55,000 Da to about 60,000 Da. In an example, the average molecular weight (Mₙ) of the modified PHA is from about 200 to about 300 Da.

The modified PHA of the present disclosure may be semi-crystalline (i.e., a mixture of crystalline and amorphous structures), amorphous, thermoset, or a combination thereof. The modified PHA of the present disclosure may have a crystallinity of about 10% or less, about 9% or less, about 8% or less, about 7% or less, about 6% or less, about 5% or less, about 4% or less, about 3% or less, about 2% or less, about 1% or less, about 0.5% or less, or about 0.1% or less. In preferred embodiments, the modified PHA has a crystallinity of 0% or approximately 0% (i.e., amorphous).

The modified PHA of the present disclosure may have a glass-transition temperature (T_{g}) from about −40° ° C. to about 0° C.; for example, about −40° C., −35° C., −30° C., −25° C., −20° C., −15° C., −10° C., −5° C., or about 0° C. The modified PHA of the present disclosure may have a T_{g} from about −40° C. to about −30° C., about −40° C. to about −20° C., about −40° C. to about −10° C., about −40° C. to about 0° C., about −30° C. to about 0° C., about −20° C. to about 0° C., or about −10° C. to about 0° C. In preferred embodiments, the modified PHA of the present disclosure has a T_{g} from about −30° C. to about −5° C., or more preferably from about −20° C. to about −8° C., or even more preferably from about −12° C. to about −18° C.

The modified PHA may comprise 3-hydroxyalkanoate monomer units or 4-hydroxyalkanoate monomer units, or both. The modified PHA may comprise from about 0% to about 20% 3-hydroxyalkanoate monomer units, such as from about 0% to about 5%, about 0% to about 10%, about 0% to about 15%, about 0% to about 20%, about 5% to about 20%, about 10% to about 20%, or about 15% to about 20% 3-hydroxyalkanoate monomer units. The 3-hydroxyalkanoate monomer units may comprise a carbon chain having from 4 to 30 carbons, or from 12 to 24 carbons. Preferably, the carbon chain comprises at least one point of unsaturation. In some embodiments, the carbon chain comprises 1-3 points of unsaturation. Preferably, the point of unsaturation occurs on the side chain of the monomer unit. In some embodiments, the 3-hydroxyalkanoate monomer units may be derived from unsaturated fatty acids.

Additionally or alternatively, the modified PHA may comprise from about 0% to about 20% 4-hydroxyalkanoate monomer units, such as from about 0% to about 5%, about 0% to about 10%, about 0% to about 15%, about 0% to about 20%, about 5% to about 20%, about 10% to about 20%, or about 15% to about 20% 4-hydroxyalkanoate monomer units. The 4-hydroxyalkanoate monomer units may comprise a carbon chain having from 4 to 30 carbons, or from 12 to 24 carbons. Preferably, the carbon chain may comprise at least one point of unsaturation, at least two points of unsaturation, or at least three points of unsaturation. In some embodiments, the carbon chain may comprise 1-5 points of unsaturation. Preferably, the point of unsaturation occurs on the side chain of the monomer unit. In some embodiments, the 4-hydroxyalkanoate monomer units may be derived from unsaturated fatty acids.

In a preferred embodiment, the modified PHA comprises from about 0% to about 20% monomers of 3-hydroxy-10-undecylenic acid or derivatives thereof, such as from about 0% to about 5%, about 0% to about 10%, about 0% to about 15%, about 0% to about 20%, about 5% to about 20%, about 10% to about 20%, or about 15% to about 20% monomer units of 3-hydroxy-10-undecylenic acid or derivatives thereof. Derivatives of 3-hydroxy-10-undecylenic acid may include 3-hydroxy-10-undecylenic acid substituted with one or more functional groups, such as a halogen, hydroxyl, alkyl, aryl, nitrile, or a combination thereof.

In another preferred embodiment, the modified PHA comprises 3-hydroxyalkanoate monomer units including a carbon chain having 11 carbon atoms and a point of unsaturation at a terminus of the carbon chain.

The 3-hydroxyalkanoate monomer units or 4-hydroxyalkanoate monomer units in the modified PHA may comprise an epoxide functional group at the terminus of the side chain. In some embodiments, from about 30% to about 99% of the 3-hydroxyalkanoate monomer units in the modified PHA may comprise an epoxide functional group at the terminus of the side chain, such as from about 30% to about 40%, about 30% to about 50%, about 30% to about 60%, about 30% to about 70%, about 30% to about 80%, about 30% to about 90%, about 30% to about 99%, about 40% to about 99%, about 50% to about 99%, about 60% to about 99%, about 70% to about 99%, about 80% to about 99%, about 90% to about 99%, about 40% to about 80%, or about 50% to about 70%. In some embodiments, from about 30% to about 99% of the 4-hydroxyalkanoate monomer units in the modified PHA may comprise an epoxide functional group at the terminus of the side chain, such as from about 30% to about 40%, about 30% to about 50%, about 30% to about 60%, about 30% to about 70%, about 30% to about 80%, about 30% to about 90%, about 30% to about 99%, about 40% to about 99%, about 50% to about 99%, about 60% to about 99%, about 70% to about 99%, about 80% to about 99%, about 90% to about 99%, about 40% to about 80%, or about 50% to about 70%.

Preferably, the modified PHA has low levels of cross-linking such that the modified PHA is soluble in an organic solvent but maintains high levels of viscosity (i.e., from about 5,000 Pa·s to about 5,000,000 Pa·s) and molecular weight (i.e., from about 5,000 to about 60,000 Da). The viscosity of the modified PHA may be from about 5,000 Pas to about 5,000,000 Pa·s, such as from about 5,000 Pas to about 10,000 Pas, about 5,000 to about 50,000 Pa·s, about 5,000 Pa·s to about 100,000 Pa·s, about 5,000 Pa·s to about 500,000 Pa·s, about 5,000 Pa·s to about 1,000,000 Pa·s, about 5,000 Pa·s to about 5,000,000 Pa·s, about 10,000 Pa·s to about 5,000,000 Pa·s, about 50,000 Pa·s to about 5,000,000 Pa·s, about 100,000 Pa·s to about 5,000,000 Pa·s, about 500,000 Pa·s to about 5,000,000 Pa·s, about 1,000,000 Pa·s to about 5,000,000 Pa·s, about 10,000 Pa·s to about 1,000,000 Pa·s, or about 50,000 Pa·s to about 500,000 Pa·s.

The compound and/or modified PHA of the present disclosure may comprise the formula:

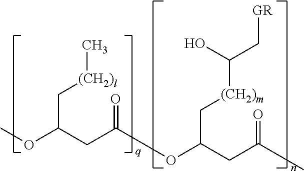

wherein l is an integer from 0 to 20, m is an integer from 0 to 20, n and q are integers wherein the sum of n and q is from 20 to 200, the ratio of q to n is between 0 and 1, and GR is a plant-based acid nucleophile. It is to be understood that in the above formula, the alkyl side chain denoted by q and the side chain comprising the GR group denoted by n may alternate evenly as shown or may occur in a random pattern along the polymer chain. In some embodiments, the termini of the modified PHA molecule may be as shown below:

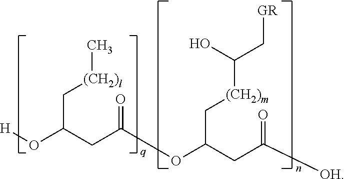

This modified PHA composition may be formed when the plant-based acid nucleophile is added in an amount greater than 30% by weight to the PHA. The plant-based acid nucleophile may be added in an amount of about 30% or greater, about 50% or greater, about 70% or greater, or about 90% or greater. In other embodiments, the plant-based acid nucleophile may be added in an amount from about 30% to about 100% by weight of the PHA, such as from about 30% to about 50%, about 30% to about 70%, about 30% to about 90%, about 30% to about 95%, about 30% to about 100%, about 50% to about 100%, about 70% to about 100%, about 90% to about 100%, or about 95% to about 100% by weight of the PHA. Without wishing to be bound by theory, this may be the result of epoxide ring opening under acid/base catalysis wherein the plant-based acid nucleophile reacts with an epoxide on the PHA and the sequence terminates with the ring opened adduct.

In some embodiments, l may be 0, 1, 2, 3, 4, 5, 6, 7, 8, 9, 10, 11, 12, 13, 14, 15, 16, 17, 18, 19, or 20. In some additional embodiments, l may be from 0 to 5, 0 to 10, 0 to 15, 0 to 20, 5 to 10, 5 to 15, 5 to 20, 10 to 15, 10 to 20, or 15 to 20. In preferred embodiments, l is from 1 to 5. In some embodiments, l may be greater than 20.

In some embodiments, m may be 0, 1, 2, 3, 4, 5, 6, 7, 8, 9, 10, 11, 12, 13, 14, 15, 16, 17, 18, 19, or 20. In some additional embodiments, m may be from 0 to 5, 0 to 10, 0 to 15, 0 to 20, 5 to 10, 5 to 15, 5 to 20, 10 to 15, 10 to 20, or 15 to 20. In preferred embodiments, m is from 1 to 6. In some embodiments, m may be greater than 20.

In some embodiments, n may be about 1, 2, 3, 4, 5, 6, 7, 8, 9, 10, 15, 20, 25, 30, 35, 40, 45, 50, 55, 60, 65, 70, 75, 80, 85, 90, 95, 100, 110, 120, 130, 140, 150, 160, 170, 180, 190, or about 200. In some additional embodiments, n may be from about 1 to about 10, about 1 to about 20, about 1 to about 50, about 1 to about 100, about 1 to about 150, about 1 to about 200, about 10 to about 200, about 20 to about 200, about 50 to about 200, about 100 to about 200, or about 150 to about 200. In some embodiments, n may be greater than 200.

In some embodiments, q may be about 1, 2, 3, 4, 5, 6, 7, 8, 9, 10, 15, 20, 25, 30, 35, 40, 45, 50, 55, 60, 65, 70, 75, 80, 85, 90, 95, 100, 110, 120, 130, 140, 150, 160, 170, 180, 190, or about 200. In some additional embodiments, q may be from about 1 to about 10, about 1 to about 20, about 1 to about 50, about 1 to about 100, about 1 to about 150, about 1 to about 200, about 10 to about 200, about 20 to about 200, about 50 to about 200, about 100 to about 200, or about 150 to about 200. In some embodiments, q may be greater than 200.

In some embodiments, the sum of n+q may be about, 20, 25, 30, 35, 40, 45, 50, 55, 60, 65, 70, 75, 80, 85, 90, 95, 100, 110, 120, 130, 140, 150, 160, 170, 180, 190, or about 200. In some additional embodiments, the sum of n+q may be from about 20 to about 50, about 20 to about 100, about 20 to about 150, about 20 to about 200, about 50 to about 200, about 100 to about 200, or about 150 to about 200. In some embodiments, the sum of n+q may be greater than 200.

In some embodiments, the ratio of n to q may be from 0 and 1, such as about 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, or about 1. In some additional embodiments, the ratio of n to q may be from about 0 to about 0.01, about 0 to about 0.05, about 0 to about 0.1, about 0 to about 0.25, about 0 to about 0.5, about 0 to about 0.75, about 0 to about 1, about 0.01 to about 1, about 0.1 to about 1, about 0.25 to about 1, about 0.5 to about 1, or about 0.75 to about 1. In preferred embodiments, q is from about 0.01 to about 0.20. In other preferred embodiments, the ratio of n to q is from about 0 to about 0.01.

The compound and/or modified PHA may comprise the formula:

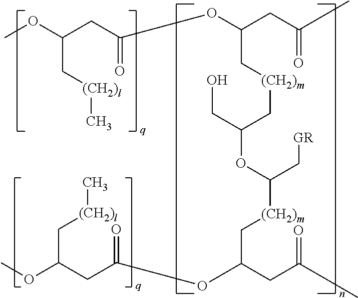

wherein l is an integer from 0 to 20 as described above, m is an integer from 0 to 20 as described above, n and q are each integers greater than 0, wherein the sum of n and q is from 20 to 200 as described above, the ratio of q to n is between 0 and 1 as described above, and GR is a plant-based acid nucleophile as described above. In an exemplary embodiment, l=4, m=5, n is an integer from 30 to 50, and the ratio of q to n is 0.1. This modified PHA composition may result from addition of less than 30 wt % of the PHA. Without wishing to be bound by theory, it is believed that the plant-based acid nucleophile acts as an initiator to epoxide ring opening followed by reaction of the resulting hydroxy group with another epoxide, thereby effecting crosslinking of polymer chains and leading to thermoset materials. The terminus of the modified PHA may comprise H, a hydroxyl group (—OH), or -GR. In an embodiment, the termini of the modified PHA may be:

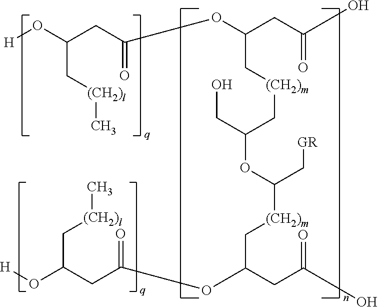

A composition of the present disclosure may comprise a mixture of modified PHAs. The mixture may comprise a first PHA having the formula:

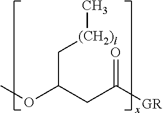

and a second PHA having the formula:

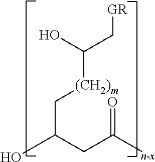

wherein l is an integer from 0 to 20 as described above, m is an integer from 0 to 20 as described above, n is an integer from 20 to 200 as described above, x is an integer from 20-30, the ratio of q to n is from 0 to 1 as described above, and GR is a plant-based acid nucleophile. In some embodiments, x may be an integer from 20 to 25 or from 25 to 30, such as 20, 21, 22, 23, 24, 25, 26, 27, 28, 29, or 30. In an exemplary embodiment, l=4, m=5, n is an integer from 30 to 50, x is an integer from 20 to 30, and the ratio of q to n=0.1. This composition may be achieved by adding the plant-based acid nucleophile in an amount greater than 30 wt % of the PHA. Without wishing to be bound by theory, it is believed that in addition to epoxide ring opening, reaction of the acid functionality of the gum rosin with the PHA esters can result in transesterification and molecular weight reduction.

Preferably, GR comprises any plant-based acid acting as nucleophile described herein or a derivative thereof. In preferred embodiments GR comprises a diterpene acid or a derivative thereof. In additional preferred embodiments, GR comprises a compound having the formula:

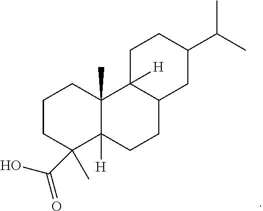

When bound to the modified PHA, this compound has the formula:

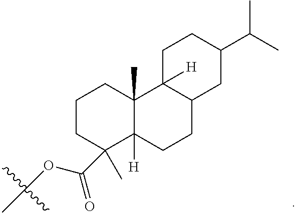

### II. Methods

Further provided herein are methods for synthesizing modified PHAs. The methods generally comprise contacting an epoxidized PHA with a plant-based acid acting as a nucleophile in the presence of a catalyst, thereby forming the modified PHA. The epoxidized PHA may be any PHA described herein with at least one epoxide functional group. The plant-based acid acting as a nucleophile may be any plant-based acid acting as a nucleophile described herein.

The contacting may occur in an organic solvent. The organic solvent may comprise dichloromethane, acetone, ethyl acetate, or other organic solvents known in the art and combinations thereof.

The catalyst may comprise an amine catalyst. The amine catalyst may comprise ammonia, primary amines, secondary amines, tertiary amines, or combinations thereof. The primary amines may include alkyl amines like ethylamine, propylamine, isopropylamine, or combinations thereof. The secondary amines may include diethylamine. The tertiary amines may include triethylamine.

The contacting may occur at a temperature from about 50° C. to about 160° C.; for example, about 50° C., 60° C., 70° C., 80° C., 90° C., 100° ° C., 110° C., 120° C., 130° C., 140° C., 150° C., or about 160° C. In some embodiments, the contacting may occur at a temperature from about 50° C. to about 75° C., about 50° C. to about 100° C., about 50° C. to about 125° C., about 50° C. to about 160° C., about 100° ° C. to about 160° C., about 100° C. to about 140° C., or about 120° C.

The contacting may occur for a period of time from about 1 hour to about 7 days; such as from about 1 hour, 2 hours, 4 hours, 8 hours, 12 hours, 16 hours, 24 hours, 36 hours, 48 hours, 72 hours, 4 days, 5 days, 6 days, or 7 days. In some embodiments, the contacting may occur for a period of time from about 1 hour to about 48 hours, from about 8 hours to about 48 hours, or from about 16 hours to about 36 hours. Preferably, the contacting occurs for a period of about 24 hours.

The epoxidized PHA may comprise less than 2 wt % benzoic acid. Benzoic acid may form as a result of peroxidation of the PHA. The epoxidized PHA may comprise less than 2 wt % benzoic acid, such as less than 1.5 wt % benzoic acid, less than 1 wt % benzoic acid, less than 0.9 wt % benzoic acid, less than 0.8 wt % benzoic acid, less than 0.7 wt % benzoic acid, less than 0.6 wt % benzoic acid, less than 0.5 wt % benzoic acid, less than 0.4 wt % benzoic acid, less than 0.3 wt % benzoic acid, less than 0.2 wt % benzoic acid, less than 0.1 wt % benzoic acid, or less than 0.01 wt % benzoic acid. Preferably, the epoxidized PHA is substantially free of benzoic acid (e.g., less than 0.01 wt % benzoic acid).

The method may further comprise epoxidizing a PHA comprising a monomer unit with at least one point of unsaturation to form an epoxidized PHA prior to the contacting. The epoxidizing may be performed by contacting the PHA with an epoxidizing agent. The epoxidizing agent may be any epoxidizing agent known in the art, such as: a mixture of formic acid and hydrogen peroxide; meta-chloroperbenzoic acid; a mixture of formic acid, hydrogen peroxide, and a heavy metal catalyst (Mn, Ti, W, Mo, Al, Nb, Re, or combinations thereof); tert-butyl hydroperoxide with a Ti, Mo, and Al catalyst; a mixture of formic acid and sodium hypochlorite; sodium chlorite in an organic solvent; sodium hypochlorite in an organic solvent with a potassium bromide system reflux; and other epoxidizing agents known in the art and combinations thereof.

In an exemplary embodiment, the method comprises epoxidizing a PHA having the formula

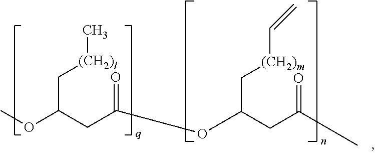

wherein the termini of the PHA may include —H or —OH, thereby forming an epoxidized PHA having the formula:

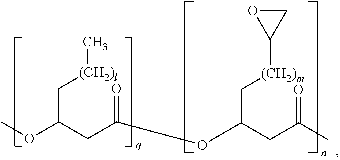

wherein the termini of the epoxidized PHA may include —H or —OH; and contacting the epoxidized PHA with a plant-based acid acting as a nucleophile in the presence of a catalyst, thereby forming the modified PHA, wherein l is an integer from 0 to 20, m is an integer from 0 to 20, n and q are each integers greater than or equal to zero, wherein the sum of n and q is from 1 to 200, and the ratio of q to n is between 0 and 1. As noted above with respect to the modified PHAs in section l, it should be understood that the monomer units denoted by q and n may occur in an alternating pattern as shown or may occur in a random order along the polymer chain.

In another embodiment, the method comprises oxidizing a first PHA having the formula:

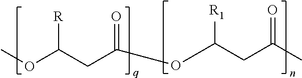

wherein the termini of the first PHA includes —H or —OH, thereby forming an oxidized PHA having the formula:

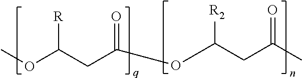

wherein the termini of the oxidized PHA includes —H or —OH and contacting the oxidized PHA with a plant-based acid acting as a nucleophile in the presence of a catalyst, thereby forming the modified PHA, wherein R is H, CH₃, or a C₂-C₂₇ alkyl, such as a C₂-C₂₀ alkyl, a C₂-C₁₅ alkyl, a C₂-C₁₀ alkyl, or a C₂-C₈ alkyl; R₁ is a C₂-C₂₁ alkenyl, such as a C₂-C₂₀ alkenyl, a C₂-C₁₅ alkenyl, a C₂-C₁₀ alkenyl, or a C₂-C₈ alkenyl; R₂ is an epoxide or a C₁-C₂₇ epoxide, such as a C₁-C₂₀ epoxide, a C₁-C₁₅ epoxide, a C₁-C₁₀ epoxide, or a C₁-C₈ epoxide; n and q are each integers greater than or equal to 0, wherein the sum of n and q is from 1 to 200; and the ratio of q to n is between 0 and 1. Preferably, R₂ is an epoxide derivative of R₁. As used herein an “epoxide derivative” of a particular chemical substituent refers to the particular chemical substituent substituted with an epoxide functional group. As a non-limiting example, an epoxide derivative of a C₂ alkenyl would be a C₂ alkyl substituted with an epoxide group. The epoxide functional group is substituted at the point of unsaturation of the alkenyl. Preferably, the point of unsaturation of the alkenyl is at the terminus of the alkenyl. A C₁-C₂₇ epoxide is defined as an alkyl comprising 1-27 carbons and an epoxide group. Preferably, the C₁-C₂₇ epoxide is linear.

### Definitions

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.” The endpoint may also be based on the variability allowed by an appropriate regulatory body, such as the FDA, USP, etc.

When introducing elements of the embodiments described herein, the articles “a”, “an”, “the” and “said” are intended to mean that there are one or more of the elements. The terms “comprising”, “including” and “having” are intended to be inclusive and mean that there may be additional elements other than the listed elements.

Unless otherwise indicated, the molecular weight for the polymers described herein refers to the number-average molecular weight of the polymer, often abbreviated as “Mₙ”.

Terms used herein may be preceded and/or followed by a single dash, “—”, or a double dash, “═”, to indicate the bond order of the bond between the named substituent and its parent moiety; a single dash indicates a single bond and a double dash indicates a double bond. In the absence of a single or double dash it is understood that a single bond is formed between the substituent and its parent moiety; further, substituents are intended to be read “left to right” (i.e., the attachment is via the last portion of the name) unless a dash indicates otherwise. For example, C₁-C₆alkoxycarbonyloxy and —OC(O)C₁-C₆alkyl indicate the same functionality; similarly arylalkyl and -alkylaryl indicate the same functionality.

The term “alkenyl” as used herein, means a straight or branched chain hydrocarbon containing from 2 to 10 carbons, unless otherwise specified, and containing at least one carbon-carbon double bond. Representative examples of alkenyl include, but are not limited to, ethenyl, 2-propenyl, 2-methyl-2-propenyl, 3-butenyl, 4-pentenyl, 5-hexenyl, 2-heptenyl, 2-methyl-1-heptenyl, 3-decenyl, and 3,7-dimethylocta-2,6-dienyl.

The term “alkyl” as used herein, means a straight or branched chain hydrocarbon containing from 1 to 10 carbon atoms unless otherwise specified. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, and n-decyl. When an “alkyl” group is a linking group between two other moieties, then it may also be a straight or branched chain; examples include, but are not limited to —CH₂—, —CH₂CH₂—, —CH₂CH₂CHC(CH₃)—, and —CH₂CH(CH₂CH₃)CH₂—.

The term “alkynyl” as used herein, means a straight or branched chain hydrocarbon group containing from 2 to 10 carbon atoms and containing at least one carbon-carbon triple bond. Representative examples of alkynyl include, but are not limited, to acetylenyl, 1-propynyl, 2-propynyl, 3-butynyl, 2-pentynyl, and 1-butynyl.

The term “substituted”, as used herein, means that a hydrogen radical of the designated moiety is replaced with the radical of a specified substituent, provided that the substitution results in a stable or chemically feasible compound. The term “substitutable”, when used in reference to a designated atom, means that attached to the atom is a hydrogen radical, which can be replaced with the radical of a suitable substituent.

The term “thermoset”, as used herein, refers to a material that strengthens when cured, but cannot be remolded after the initial forming. Thermoset materials cannot fully dissolve in any solvent.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

It will be appreciated that the compositions and methods described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of the disclosure.

### Enumerated Embodiments

Embodiment 1: A composition having the formula:

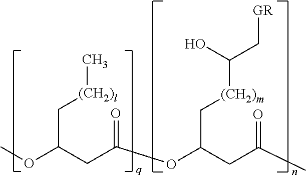

wherein:
l is an integer from 0 to 20;
m is an integer from 0 to 20;
n and q are each integers greater than zero, wherein the sum of n and q is from 20 to 200;
a ratio of q to n is between 0 and 1; and
GR is a plant-based acid nucleophile.

Embodiment 2: The composition of embodiment 1, wherein l is an integer from 1 to 5.

Embodiment 3: The composition of embodiment 1 or 2, wherein m is an integer from 1 to 6.

Embodiment 4: The composition of any one of embodiments 1-3, wherein the ratio of q to n is from 0.01 to 0.20.

Embodiment 5: The composition of any one of embodiments 1-3, wherein the ratio of q to n is from 0 to 0.01.

Embodiment 6: The composition of any one of embodiments 1-5, wherein the composition has the formula:

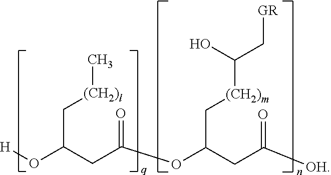

Embodiment 7: The composition of any one of embodiments 1-6, wherein GR has a molecular weight from about 50 Da to about 1,000 Da.

Embodiment 8: The composition of any one of embodiments 1-7, wherein GR is a diterpene acid or a derivative thereof.

Embodiment 9: The composition of any one of embodiments 1-8, wherein GR has the formula:

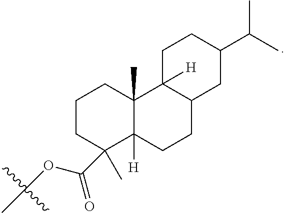

Embodiment 10: The composition of any one of embodiments 1-9, wherein the composition has a molecular weight from about 5,000 Da to about 60,000 Da.

Embodiment 11: The composition of any one of embodiments 1-10, wherein the composition has a molecular weight from about 5,000 Da to about 10,000 Da.

Embodiment 12: The composition of any one of embodiments 1-10, wherein the composition has a molecular weight from about 10,000 Da to about 20,000 Da.

Embodiment 13: The composition of any one of embodiments 1-10, wherein the composition has a molecular weight from about 20,000 Da to about 30,000 Da.

Embodiment 14: The composition of any one of embodiments 1-10, wherein the composition has a molecular weight from about 30,000 Da to about 40,000 Da.

Embodiment 15: The composition of any one of embodiments 1-10, wherein the composition has a molecular weight from about 40,000 Da to about 60,000 Da.

Embodiment 16: The composition of any one of embodiments 1-10, wherein the composition has a molecular weight from about 5,000 Da to about 15,000 Da.

Embodiment 17: The composition of any one of embodiments 1-16, wherein the composition has a crystallinity of about 10% or less.

Embodiment 18: The composition of any one of embodiments 1-17, wherein the composition has a crystallinity of about 5% or less.

Embodiment 19: The composition of any one of embodiments 1-18, wherein the composition has a crystallinity of about 3% or less.

Embodiment 20: The composition of any one of embodiments 1-19, wherein the composition has a crystallinity of about 1% or less.

Embodiment 21: The composition of any one of embodiments 1-20, wherein the composition is amorphous.

Embodiment 22: The composition of any one of embodiments 1-16, wherein the composition is thermoset.

Embodiment 23: The composition of any one of embodiments 1-16, wherein the composition is semi-crystalline.

Embodiment 24: The composition of any one of embodiments 1-23, wherein the composition has a glass-transition temperature (T_{g}) from about −50° ° C. to about 20° C.

Embodiment 25: The composition of any one of embodiments 1-24, wherein the composition has a T_{g} from about −40° C. to about 0° C.

Embodiment 26: The composition of any one of embodiments 1-25, wherein the composition has a T_{g} from about −30° ° C. to about −5° C.

Embodiment 27: The composition of any one of embodiments 1-26, wherein the composition has a T_{g} from about −20° C. to about −8° C.

Embodiment 28: A composition comprising a modified polyhydroxyalkanoate (PHA), wherein the modified PHA comprises 3-hydroxyalkanoate monomer units or 4-hydroxyalkanoate monomer units.

Embodiment 29: The composition of embodiment 28, wherein the modified PHA comprises from about 0% to about 20% 3-hydroxyalkanoate monomer units.

Embodiment 30: The composition of embodiment 29, wherein the 3-hydroxyalkanoate monomer units comprise a carbon chain having from 4 to 30 carbons, wherein the carbon chain includes at least one point of unsaturation.

Embodiment 31: The composition of embodiment 30, wherein the carbon chain has from 12 to 24 carbons.

Embodiment 32: The composition of any one of embodiments 28-31, wherein the modified PHA comprises from about 0% to about 20% 4-hydroxyalkanoate monomer units.

Embodiment 33: The composition of embodiment 32, wherein the 4-hydroxyalkanoate monomer units comprise a carbon chain having from 4 to 30 carbons, wherein the carbon chain includes at least one point of unsaturation.

Embodiment 34: The composition of embodiment 33, wherein the carbon chain has from 12 to 24 carbons.

Embodiment 35: The composition of any one of embodiments 28-34, wherein the modified PHA comprises from about 0% to about 20% monomers that are derived from 3-hydroxy-10-undecylenic acid.

Embodiment 36: The composition of any one of embodiments 28-35, wherein the modified PHA comprises 3-hydroxyalkanoate monomer units including a carbon chain having 11 carbon atoms and a point of unsaturation at a terminus of the carbon chain.

Embodiment 37: The composition of any one of embodiments 28-36, wherein the 3-hydroxyalkanoate monomer units or the 4-hydroxyalkanoate monomer units include from 1 to 3 points of unsaturation.

Embodiment 38: The composition of any one of embodiments 28-37, wherein the 3-hydroxyalkanoate monomer units or the 4-hydroxyalkanoate monomer units are derived from unsaturated fatty acids.

Embodiment 39: The composition of any one of embodiments 28-38, wherein greater than 30% of the 3-hydroxyalkanoate monomer units or the 4-hydroxyalkanoate monomer units comprise an epoxide functional group at a terminus of a side chain.

Embodiment 40: The composition of embodiment 39, wherein from 30% to 99% of the 3-hydroxyalkanoate monomer units or the 4-hydroxyalkanoate monomer units comprise an epoxide functional group at a terminus of a side chain.

Embodiment 41: The composition of embodiment 39, wherein from 30% to 60% of the 3-hydroxyalkanoate monomer units or the 4-hydroxyalkanoate monomer units comprise an epoxide functional group at a terminus of a side chain.

Embodiment 42: The composition of embodiment 39, wherein from 60% to 99% of the 3-hydroxyalkanoate monomer units or the 4-hydroxyalkanoate monomer units comprise an epoxide functional group at a terminus of a side chain.

Embodiment 43: The composition of embodiment 39, wherein the modified PHA has low levels of cross-linking.

Embodiment 44: A method for synthesizing modified polyhydroxyalkanoates (PHAs), the method comprising: contacting an epoxidized PHA with a plant-based acid acting as a nucleophile in the presence of a catalyst, thereby forming the modified PHA.

Embodiment 45: The method of embodiment 44, further comprising epoxidizing a PHA comprising a monomer unit with at least one point of unsaturation to form an epoxidized PHA prior to the contacting.

Embodiment 46: The method of embodiment 45, wherein the epoxidizing is performed by contacting the PHA with an epoxidizing agent.

Embodiment 47: The method of embodiment 45 or 46, wherein the catalyst comprises an amine catalyst.

Embodiment 48: The method of embodiment 47, wherein the amine catalyst comprises ammonia, primary amines, secondary amines, tertiary amines, or combinations thereof.

Embodiment 49: The method of any one of embodiments 44-48, wherein the contacting occurs at a temperature from about 50° ° C. to about 160° C.

Embodiment 50: The method of any one of embodiments 44-49, wherein the contacting occurs at a temperature from about 100° ° C. to about 140° C.

Embodiment 51: The method of any one of embodiments 44-50, wherein the contacting occurs at a temperature of about 120° C.

Embodiment 52: The method of any one of embodiments 44-51, wherein the contacting occurs for a period from about 1 hour to about 7 days.

Embodiment 53: The method of any one of embodiments 44-52, wherein the contacting occurs for a period from about 8 hours to about 48 hours.

Embodiment 54: The method of any one of embodiments 44-53, wherein the contacting occurs for a period of about 24 hours.

Embodiment 55: The method of any one of embodiments 44-54, wherein the epoxidized PHA comprises less than 1% benzoic acid.

Embodiment 56: The method of any one of embodiments 44-55, wherein the epoxidized PHA comprises less than 0.1% benzoic acid.

Embodiment 57: The method of any one of embodiments 44-56, wherein the epoxidized PHA comprises less than 0.01% benzoic acid.

Embodiment 58: The method of any one of embodiments 44-57, wherein the epoxidized PHA is substantially free of benzoic acid.

Embodiment 59: A method for synthesizing modified polyhydroxyalkanoates (PHAs), the method comprising: epoxidizing a PHA having the formula:

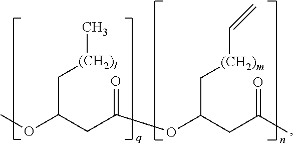

thereby forming an epoxidized PHA having the formula:

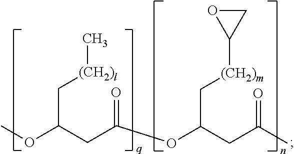

and,
contacting the epoxidized PHA with a plant-based acid acting as a nucleophile in the presence of a catalyst, thereby forming the modified PHA, wherein:
   l is an integer from 0 to 20;
   m is an integer from 0 to 20;
   n and q are each integers greater than or equal to zero, wherein the sum of n and q is from 1 to 200; and
   a ratio of q to n is between 0 and 1.

Embodiment 60: A method for synthesizing modified polyhydroxyalkanoates (PHAs), the method comprising:
oxidizing a first PHA having the formula:

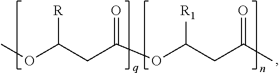

thereby forming an oxidized PHA having the formula:

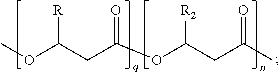

and,
contacting the oxidized PHA with a plant-based acid acting as a nucleophile in the presence of a catalyst, thereby forming the modified PHA, wherein:
   R is H, CH₃, or a C₂-C₂₇ alkyl;
   R₁ is a C₂-C₂₁ alkenyl;
   R₂ is an epoxide or a C₁-C₂₇ epoxide;
   n and q are each integers greater than or equal to 0, wherein the sum of n and q is from 1 to 200; and
   the ratio of q to n is between 0 and 1.

Embodiment 61: The method of embodiment 60, wherein R₂ is an epoxide derivative of R₁.

Embodiment 62: A composition comprising a modified polyhydroxyalkanoate (PHA) having the formula:

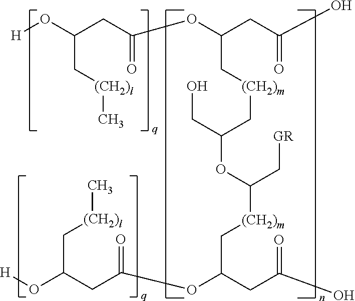

wherein:
   l=4;
   m=5;
   n and q are each integers greater than 0, wherein the sum of n and q is from 30 to 50;
   a ratio of q to n is between 0 and 1; and
GR is a plant-based acid nucleophile.

Embodiment 63: A composition comprising modified polyhydroxyalkanoates (PHAs), the composition comprising a first PHA having the formula:

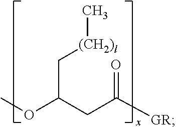

and
a second PHA having the formula:

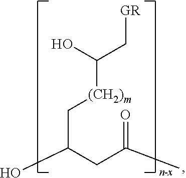

wherein
l=4;
m=5;
n is an integer from 30 to 50;
x is an integer from 20 to 30; and
GR is a plant-based acid nucleophile.

### EXAMPLES

### Example 1: Procedure for Making Modified PHA

A modified PHA of the present disclosure was made by dissolving an epoxidized PHA with gum rosin in a 1:1 ratio by weight in acetone. After the PHA and the gum rosin had completely dissolved, a TEA catalyst (5%) was added and the contents were heated at 120° C. for 24 hours.

### Example 2: Modified PHA Characteristics

A modified PHA of the present disclosure was made according to the methods described herein. The modified PHA was fully amorphous and had a static glass transition temperature of from −12° C. to −18° C. as determined by dynamic scanning calorimetry (DSC), described below. The molecular weight of the PHA was determined via gel permeation chromatography (GPC) as described below.

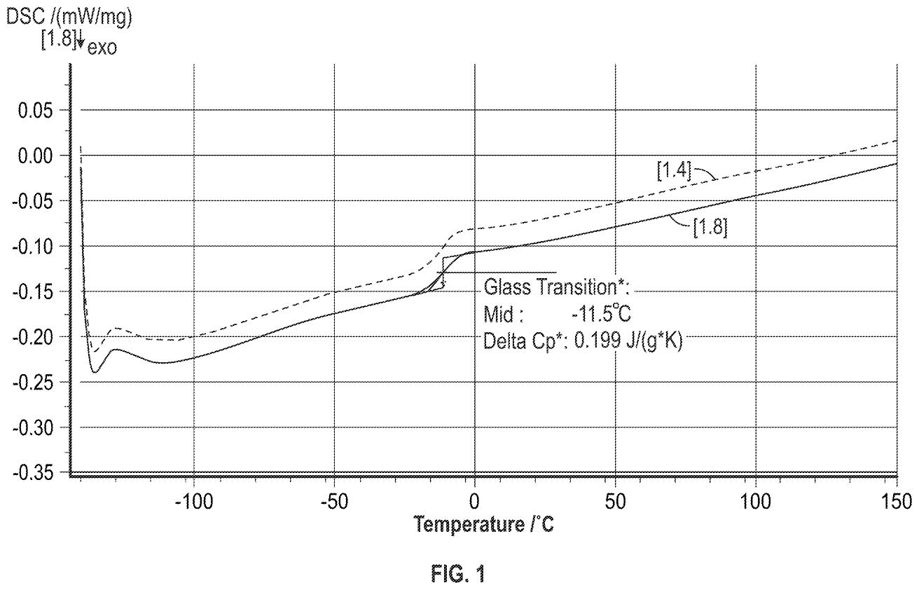

Dynamic Scanning calorimetry: The static glass transition temperature (T_{g}) was determined by means of dynamic scanning calorimetry (DSC). For this purpose, using a DSC 204 F1 from Netzsch, about 5 mg of an untreated polymer sample was weighed into an aluminum boat (volume 25 μl) and closed with a punctured lid. The measurement was made under an inert atmosphere of nitrogen. The sample was first cooled down to −150° C., then heated up to +150° C. at a heating rate of 10 K/min and cooled down again to −150° C. The subsequent second heating curve was run again at 10 K/min and the changing heat capacity was recorded. Glass transitions were recognized as steps in the thermogram shown in FIG. 1. The glass transition temperature was determined to be from −12° C. to −18° C.

The first heating cycle did not show any change in heat capacity, thus indicating a heat of fusion (melting/crystallization) after 6 months of shelf life.

Gel Permeation Chromatography: The values for molecular weights mentioned were determined by gel permeation chromatography (GPC). The measurement was carried out on 50 μl filtered sample (sample concentration approx. 3 g/l). Tetrahydrofuran was used as eluent. The measurement was carried out at 25° C. An SDV column with the specifications 5 μm, ID 8.0 mm×50 mm, was used. For separation, a column combination of three SDV columns (5 μm, ID 8.0 mm×300 mm) with individual porosities of 10³ Å, 10⁵ Å and 10⁶ Å (columns of the company Polymer Standards Service) were used. Detection was performed by a differential refractometer (PSS-SECurity 1260). The flow rate was 1 ml/min. Calibration was performed against PS (relative polystyrene calibration) standards.

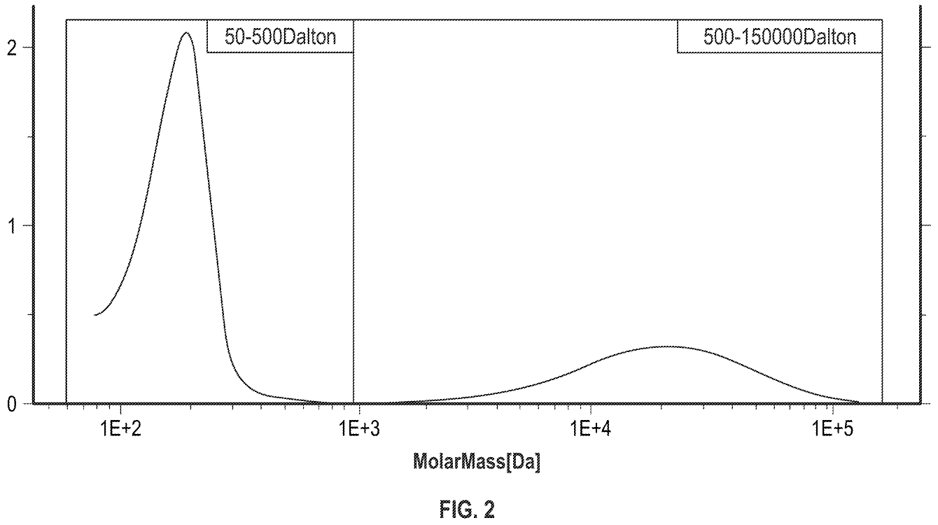

The molecular weight distribution from the sample is provided in FIG. 2. The number-average molecular weight (Mₙ), the weight-average molecular weight (M_{w}), the z-average molecular weight (M_{z}) are provided in Table 1.

TABLE 1
Gel Permeation Chromatography Results

| | | | Integral | Integral |
|---|---|---|---|---|
| Mₙ [Da] | M_{w} [Da] | M_{z} [Da] | 50-500 Da | >500 Da |
| 200 to 300 | 7400 to 8200 | 36000 to 44000 | 73-67% | 27-33% |

What is claimed is:

1. A composition having the formula: 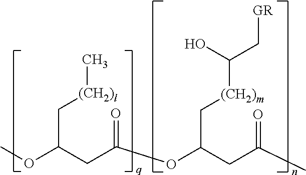
wherein:
l is an integer from 0 to 20;
m is an integer from 0 to 20;
n and q are each integers greater than zero, wherein the sum of n and q is from 20 to 200;
a ratio of q to n is between 0 and 1; and
GR is a plant-based acid nucleophile.

2. The composition of claim 1, wherein l is an integer from 1 to 5.

3. The composition of claim 1, wherein m is an integer from 6.

4. The composition of claim 1, wherein the ratio of q to n is from 0.01 to 0.20.

5. The composition of claim 1, wherein the ratio of q to n is from 0 to 0.01.

6. The composition of claim 1, wherein the composition has the formula:

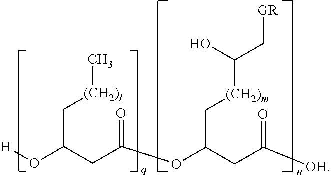

7. The composition of claim 1, wherein GR has a molecular weight from about 50 Da to about 1,000 Da.

8. The composition of claim 1, wherein GR is a diterpene acid or a derivative thereof.

9. The composition of claim 8, wherein GR has the formula:

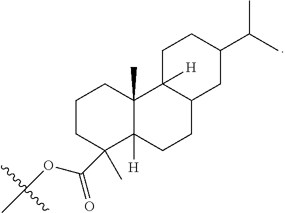

10. The composition of claim 1, wherein the composition has a molecular weight from about 5,000 Da to about 60,000 Da.

11. The composition of claim 1, wherein the composition has a crystallinity of about 10% or less.

12. The composition of claim 1, wherein the composition is amorphous.

13. The composition of claim 1, wherein the composition is thermoset.

14. The composition of claim 1, wherein the composition is semi-crystalline.

15. The composition of claim 1, wherein the composition has a glass-transition temperature (T_{g}) from about −50° ° C. to about 20° C.

16. The composition of claim 15, wherein the composition has a T_{g} from about −40° C. to about 0° C.

17. The composition of claim 15, wherein the composition has a T_{g} from about −20° C. to about −8° C.

18. A method for synthesizing modified polyhydroxyalkanoates (PHAs), the method comprising:
contacting an epoxidized PHA with a plant-based acid acting as a nucleophile in the presence of a catalyst, thereby forming the modified PHA.

19. The method of claim 18, further comprising epoxidizing a PHA comprising a monomer unit with at least one point of unsaturation to form an epoxidized PHA prior to the contacting.

20. A method for synthesizing modified polyhydroxyalkanoates (PHAs), the method comprising:
epoxidizing a PHA having the formula: 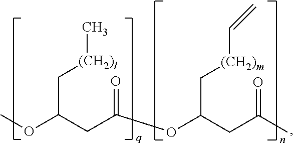
thereby forming an epoxidized PHA having the formula: 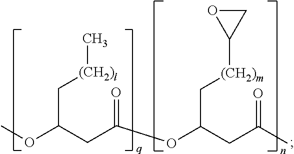
and,
contacting the epoxidized PHA with a plant-based acid acting as a nucleophile in the presence of a catalyst, thereby forming the modified PHA, wherein:
l is an integer from 0 to 20;
m is an integer from 0 to 20;
n and q are each integers greater than or equal to zero, wherein the sum of n and q is from 1 to 200; and
a ratio of q to n is between 0 and 1.
